(19) United States
(12) Patent Application Publication
(10) Pub. No.: US 2007/0000527 A1
(43) Pub. Date: Jan. 4, 2007

(54) Workpiece support for use in a process vessel and system for treating microelectronic workpieces

(76) Inventors: Brian K. Aegerter, Kalispell, MT (US); Daniel J. Woodruff, Kalispell, MT (US); Coby S. Grove, Whitefish, MT (US); Gregory J. Wilson, Kalispell, MT (US)

Correspondence Address: WALLENSTEIN & WAGNER, LTD., 311 SOUTH WACKER DRIVE, 53RD FLOOR, CHICAGO, IL, 60606, US

(21) Appl. No.: 11/172,162

(22) Filed: Jun. 30, 2005

(51) Int. Cl. B08B 3/00

(52) U.S. Cl. 134/149; 134/153; 134/902

(57) ABSTRACT

A workpiece support apparatus for use in a process vessel and process system for treating semiconductor workpieces. The process vessel is to be utilized in an integrated tool for wet chemical treatment of a semiconductor workpiece. The workpiece support apparatus includes a rotor having a central cavity and guide pins mounted at an outer perimeter. A workpiece support having extendable workpiece support fingers is connected to the rotor. The extendable workpiece support fingers are moveable from a first position to a second position. A bellows seal connects the workpiece support to the rotor. A fluid delivery tube is positioned in the central cavity of the rotor and connected to a supply of fluid. When the extendable workpiece support fingers are in the first position, the guide pins of the rotor cannot interfere with the loading of a workpiece onto the extendable workpiece support fingers, and when the extendable workpiece support fingers are in the second position, a pressurized fluid is delivered through the delivery tube to create a low pressure region adjacent an inner surface of the workpiece, lifting the workpiece off the extendable workpiece support fingers, exposing the entire backside of the workpiece for processing.

### CROSS-REFERENCE TO RELATED APPLICATIONS

Not Applicable

### TECHNICAL FIELD

The invention relates to surface preparation, cleaning, rinsing and drying of workpieces, such as semiconductor wafers, flat panel displays, rigid disk or optical media, thin film heads or other workpieces formed from a substrate on which microelectronic circuits, data storage elements or layers, or micro-mechanical elements may be formed. These and similar articles are collectively referred to herein as a “wafer” or “workpiece.” Specifically, the present invention relates to a workpiece support for use in a process vessel and process system for wet chemical treating semiconductor workpieces.

### BACKGROUND

Semiconductor wafer processing in the manufacture of integrated circuits and micromachines is increasingly complex. Wafer sizes are getting larger—typically 300 mm presently—and feature sizes for interconnect wiring are getting smaller with higher aspect ratios. Consequently, processes for cleaning and etching wafers in the course of manufacturing is being subjected to more stringent specifications. In particular, wafer etching/cleaning specifications are becoming more stringent as to contamination parameters.

A significant factor in semiconductor wafer processing, insofar as concerns wafer cleaning and etching, is the interference caused by wafer holder apparatus that can lead to inefficient and deficient cleaning and etching. During wet chemical processing of wafers, such as employed in single wafer processing for cleaning and etching wafers, a wafer typically must be held during the processing. For processes in which the wafer is to be spun during the application of wet chemicals for cleaning or etching, the wafer must be held and restrained against the spinning and chemical application forces to which it is exposed.

Heretofore, the wafer is typically gripped at its edge or constrained by retainer pins and the locations at which the wafer is gripped or constrained become sources of residual contamination. In etching, the locations of gripping contact can lead to over or under etching compared with the rest of the wafer's surface. In cleaning, the same can be true. But also when cleaning involves rinsing with DI water, the locations of gripping contact can provide areas on which contaminants are lodged and remain when the wafer is ungripped.

### SUMMARY

The present invention provides a single substrate holder for wet chemical processing of substrates, such as semiconductor wafers, which secures the substrate for processing against substrate spinning and chemical delivery forces to which the substrate will be exposed. The substrate holder provides a Bernoulli chuck for a holder in which a Bernoulli fluid, a gas such as N₂, is directed across the face of the substrate under conditions in which the substrate is drawn to a spin rotor and secured in a processing position. The Bernoulli fluid is applied to the side of a substrate that is not the side to be processed. Consequently, the substrate holder does not secure the substrate in a manner that leads to locations of contamination since there is no substrate gripping contact exposed to the processing chemistry. The substrate holder also protects the side of the substrate that is not being processed from unwanted chemical contact.

The substrate holder is provided as part of a drive head assembly that is arranged to have a substrate automatically loaded by a tool system automated substrate transfer robot and then transferred to its processing position automatically upon actuation of the Bernoulli fluid flow. Also, the substrate holder is arranged to automatically release the substrate from the processing position for unloading by the tool system automated substrate transfer robot.

The present invention also provides a processing reactor or tool comprised of a wet chemical processing vessel for use with the drive head in a processing station adapted to be installed on a tool system base platform. The processing station may also include a second processing vessel above the first processing vessel and the drive head is adapted to serve either or both vessels.

### BRIEF DESCRIPTION OF THE DRAWINGS

FIG. 1 is a cross section of a workpiece support with extendable support fingers retracted in a processing position according to one aspect of the present invention.

FIG. 2 is a cross section of a workpiece support with extendable support fingers lowered in a loading/unloading position according to another aspect of the present invention.

FIG. 3 is a partial exploded view of a workpiece resting on extendable support fingers before the creation of a low pressure zone adjacent the inner surface of the workpiece.

FIG. 4 is a partial exploded view of a workpiece which has been lifted off the support fingers and into close proximity with the rotor by the creation of a low pressure zone adjacent the inner surface of the workpiece.

FIG. 5 is a partial exploded view showing the relationship between the workpiece, the support finger and the guide pin before the creation of a low pressure zone adjacent the inner surface of the workpiece.

FIG. 6 is a top perspective view of a rotor according to the present invention.

FIG. 7 is a bottom perspective view of the rotor illustrated in FIG. 6.

FIG. 8 is a partial exploded view of the fluid delivery tube positioned in a central cavity of the rotor according to one aspect of the present invention.

FIG. 9 is a partial exploded view.

FIG. 10 is a cross sectional view of a process chamber with the drive head assembly in a load position according to the present invention.

FIG. 11 is a cross sectional view of the process chamber illustrated in FIG. 10 with the drive head assembly in a first backside processing position.

FIG. 12 is a cross sectional view of the process chamber illustrated in FIG. 10 with the drive head assembly in a second backside processing position.

FIG. 13 is a cross sectional view of a process chamber of the present invention with the drive head assembly in an inverted position for loading the workpiece for device side processing of the workpiece.

FIG. 14 is a cross sectional view of the rotor illustrated in FIG. 13.

FIG. 15 is a partial exploded view of the circled area designated B in FIG. 14.

FIG. 16 is a partial exploded view of the standoffs used in the rotor of FIG. 14 when the drive head assembly is inverted in the position shown in FIG. 13.

FIG. 17 is a cross sectional view of a rotor according to another embodiment of the present invention.

FIG. 18 is a partial exploded view of the circled area designated A in FIG. 17.

FIG. 19 is a perspective view of a bowl to be used in one embodiment of the present invention.

FIG. 20 is a cross sectional view of the bowl illustrated in FIG. 14.

FIG. 21 is a perspective view of a tool having first and second processing vessels according to one embodiment of the present invention.

FIG. 22 is a cross sectional view of the tool illustrated in FIG. 21 with the drive head assembly in an inverted position between the two processing vessels for loading/unloading of the workpiece.

FIG. 23 is a cross sectional view of the tool illustrated in FIG. 21 with the drive head assembly between the two processing vessels for loading/unloading of the workpiece.

FIG. 24 is a cross sectional view of the tool illustrated in FIG. 22 with the drive head assembly elevated and the workpiece positioned for processing in the upper vessel.

FIG. 25 is a cross sectional view of the tool illustrated in FIG. 23 with the drive head assembly lowered and the workpiece positioned for processing in the lower vessel.

FIG. 26 illustrates two processing stations arranged side-by-side on a tool platform base.

FIG. 27 is a top plan view of a wet chemical processing tool configured in accordance with one embodiment of the present invention.

### DETAILED DESCRIPTION

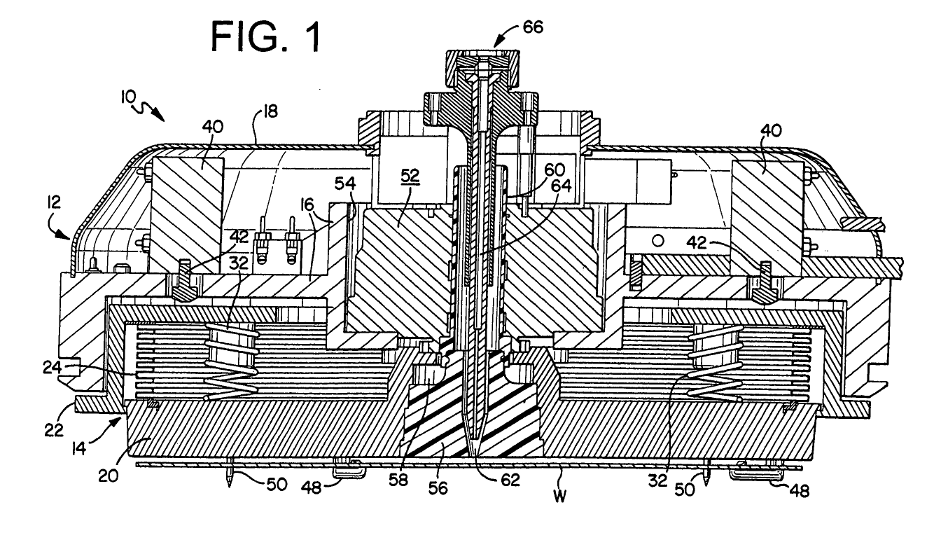

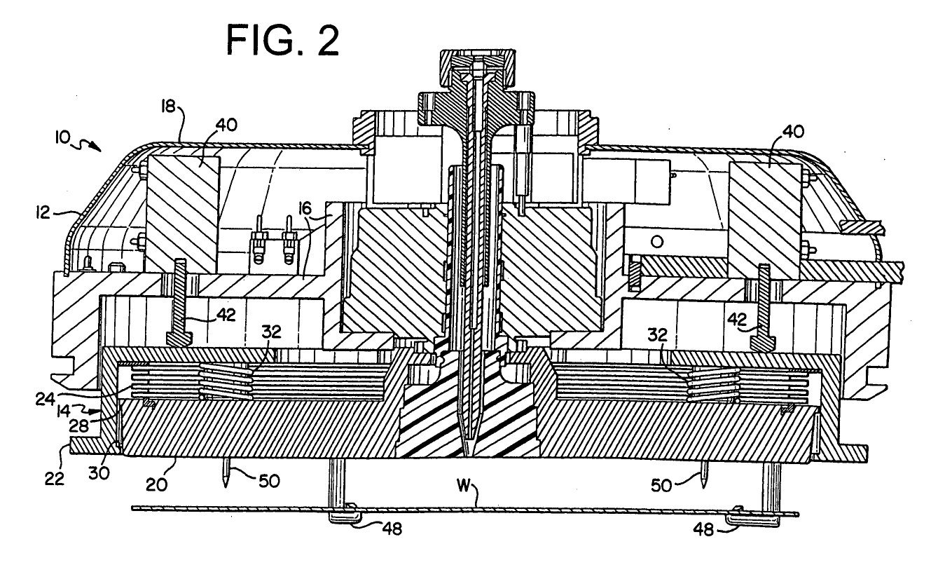

Referencing FIGS. 1 and 2, the drive head 10 comprises a stationary part 12 and a rotating part 14. The stationary part comprises a motor 52 and bearing support plate 16 and a protective cover 18. The rotating part comprises a rotor 20, a workpiece support 22 and a bellows seal 24. The rotor 20 is rotatably joined to a motor and bearing assembly 26. The workpiece support 22 is carried by the rotor 20 and is mounted such that it can be extended and retracted relative to the rotor 20 as well as rotated with the rotor 20. The bellows seal 24 is joined to inside surfaces of the rotor 20 and the workpiece support 22 to isolate the interior region between them.

Several coil springs 32 are located between and bear against the workpiece support 22 and the rotor 20 to urge the workpiece support to a retracted position as shown in FIG. 1. The workpiece support 22 and the rotor 20 have opposing peripheral lips 28, 30 located so as to limit how far the workpiece support 22 can be retracted. Several pneumatic cyclinders 40 are mounted to the support plate 16 such that their cylinder rods 42 can be extended to contact the wafer support 22. The cylinders 40 are shown in FIG. 1 retracted such that the opposing lips of the workpiece support 22 and the rotor 20 contact one another. The cylinders 40 are shown in FIG. 2 extended such that the workpiece support 22 is extended axially away from the drive head stationary part 12.

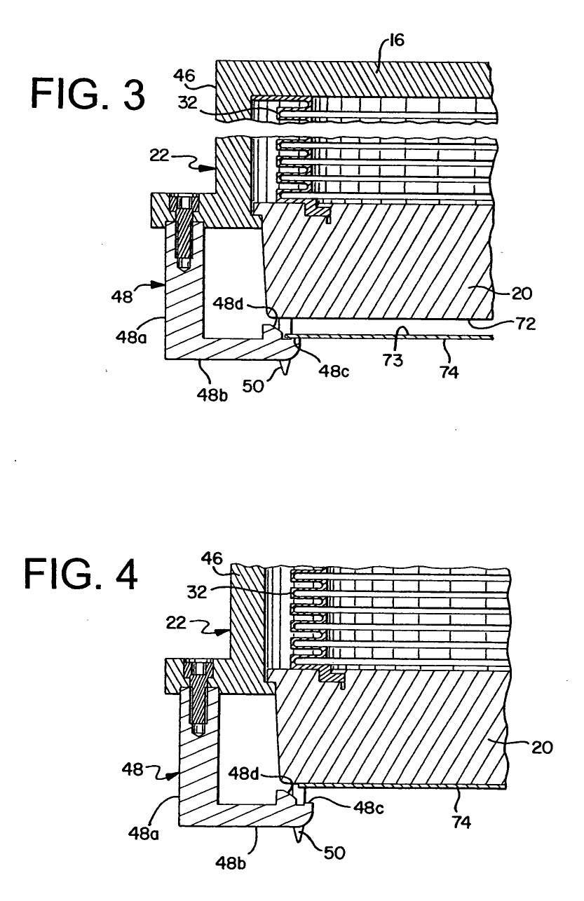

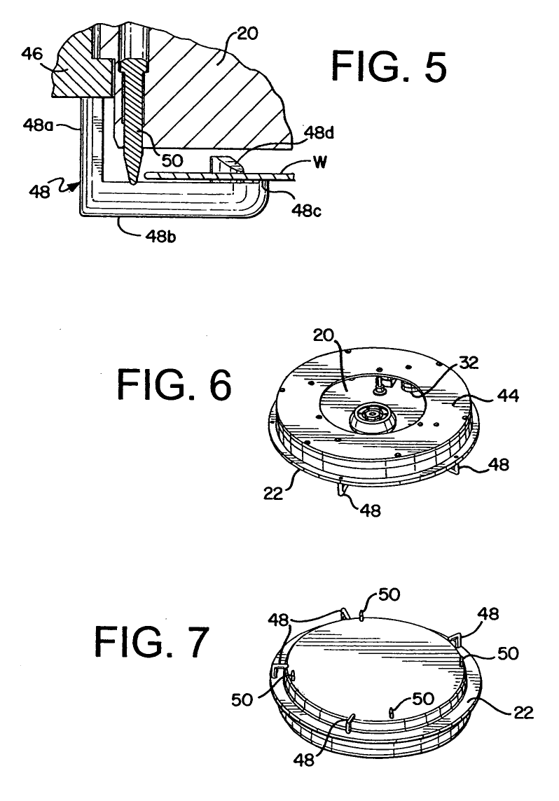

The workpiece support 22 comprises a spring support plate 44 and a peripheral skirt 46 that extends axially from the spring support plate 44. The workpiece support 22 also comprises several workpiece support fingers 48 that are mounted to the skirt 46 as shown in FIGS. 3 and 4. The rotor 20 has several radial guide pins 50 mounted at its perimeter as shown in FIG. 5. As shown in FIGS. 6 and 7, the radial guide pins 50 are spaced 90 degrees apart around the periphery of the rotor 20 so as to hold the position of a workpiece W when the rotor 20 is spun.

Also as shown in FIGS. 6 and 7, the locations of the support fingers 48 is staggered relative to the guide pins 50. As shown in FIGS. 3 and 4, the workpiece support fingers 48 are L-shaped with a vertical leg 48a attached to an annular rim 46a of skirt 46 and a horizontal leg 48b that extends radially inward. Consequently, the vertical leg 48a of each support finger 48 is located beyond the perimeter of a workpiece W and the inner end of each support finger 48 is located within the perimeter of a workpiece W. The inner end of the support finger 48 is provided with a workpiece contact surface 48c and a sloped workpiece centering surface 48d.

As shown in FIGS. 1, 3 and 4, the relative lengths to which the support fingers 48 and the guide pins 50 extend beyond their respective mountings are such that the guide pins 50 will confine a workpiece W when the workpiece support 22 is retracted. And as shown in FIG. 2, those relative lengths are also such that the guide pins 50 will not confine a workpiece W when the workpiece support 22 is extended. As shown in FIG. 2, when the workpiece support 22 is extended there is sufficient clearance between the support fingers 48 and the guide pins 50 that a workpiece W can be inserted and removed without contacting or interfering with either one. Consequently, when the workpiece support 22 is extended by actuating the pneumatic cylinders 40, a workpiece W may be inserted into the gap between the support fingers and guide pins and approximately centered and lowered onto the workpiece contacts surfaces 48c. If the workpiece W is slightly off-center it will contact one or more of the support finger centering surfaces 48c and slide into a loaded position as shown in FIG. 3. Once the workpiece W is loaded onto the support fingers 48 as shown in FIG. 3, the workpiece support 22 may be retracted by deactivating the pneumatic cylinders 40, enabling the coil springs 32 to return the workpiece support 22 to the position shown in FIG. 1, to position the workpiece for processing.

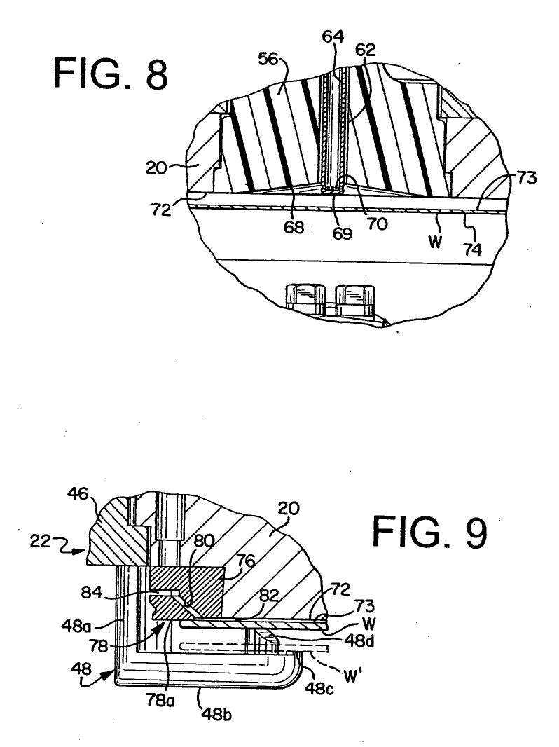

As shown in FIGS. 1 and 8, a drive head spin motor 52, located in a motor compartment 54 of motor support plate 16 is fastened to rotor 20. A solid cap 56 is threaded into a cap compartment 58 of rotor 20 and fastened to the output shaft of motor 52. This assembly spins the rotor 20 when the motor 52 operates. A center tube 60 extends axially through motor 52 and axially communicates with an axial passage 62 through cap 56 so as to provide an axial passage for a Bernoulli fluid delivery tube 64. Tube 64 extends through the center tube 60 to coupling 66 that provides for communication with a supply of fluid. Tube 64 terminates adjacent the exposed surface 68 of cap 56 in a nozzle 69. The Bernoulli nozzle shown in FIG. 8 is a series of small diameter fluid delivery ports 70 that extend radially through the wall of tube 64. The fluid exiting the delivery ports 70 is directed parallel to the plane of the workpiece W.

When a workpiece W is loaded and ready for processing, the position shown in FIGS. 3 and 8, and pressurized fluid is delivered through tube 64 and exits the radial ports 70, a Bernoulli effect is created that produces a low pressure region between the workpiece W and the combined surfaces of cap surface 68 and the adjacent surface 72 of rotor 20. As a result of the low pressure region being created, the workpiece W is drawn toward the adjacent surface 72 of rotor 20 to the position shown in FIG. 4. Consequently, the workpiece W is lifted from contact with the support fingers 48 such that the entire surface area 74 of the workpiece is exposed for processing. When the workpiece W is lifted from contact with the support fingers 48, the radial guide pins 50 maintain the workpiece W in an axially-centered position. Consequently, when the rotor 20 is spun by operation of motor 52, the workpiece W will remain in an axially-centered position by the radial guide pins 50. Because the ends of the bellows seal 32 are fastened to the rotor 20 and the wafer support skirt 46 as shown in FIG. 3, the wafer support 22 will rotate with the rotor 20.

During processing, processing fluid, which may liquids or gases, will impinge upon the exposed surface 74 of workpiece W. Also, during processing, the workpiece W will ordinarily be spun and, consequently, processing fluid will be directed by centrifugal force across the workpiece W and flung radially off the workpiece periphery. The Bernoulli fluid discharged from the nozzle 69 will also flow radially outward toward the periphery of the workpiece. Bernoulli fluid flowing outward from the workpiece W periphery will block processing fluid from contacting the inner surface 73 of the workpiece.

Consequently, for processing a workpiece W such as a semiconductor wafer that has a device side and a backside, if the device side of a workpiece is to be exposed to processing fluid, the workpiece would be loaded onto the support fingers 48 such that the exteriorly-exposed workpiece surface 74 would be the device side (i.e., the backside of the workpiece W would be adjacent surface 72 of the rotor 20). And, consequently, if the non-device side, or backside, of the workpiece is to be exposed to processing fluid, workpiece W would be loaded onto the support fingers 48 such that the exteriorly-exposed surface 74 would be the backside (i.e., the device side of the workpiece W would be adjacent surface 72 of the rotor 20).

For some process conditions, the rotor shown in FIGS. 1-8 may be modified as shown in FIG. 9. As shown in FIG. 9, the workpiece W is shown in solid line lifted from the support fingers 48 under the influence of the Bernoulli effect and in dotted line (W′) in the absence of Bernoulli fluid flow. The outer edge of the rotor 20 is modified from that shown in FIGS. 1-8 by the addition of a flow diverter 76. Flow diverter 76 is an annulus that has a workpiece support surface 78a that extends beyond the exposed surface 72 of rotor 20, and a series of fluid discharge ports 80 that extend from the terminus of the Bernoulli flow passage 82 to a circumferential discharge passage 84. Wafer support surface 78 supports the workpiece W at its outermost region, often called an “exclusion zone,” which is a peripheral area that is not used for device manufacture. As a consequence of being drawn against support surface 78, the workpiece will spin in synchronism with the rotor.

During processing, the Bernoulli fluid will travel from the nozzle 79 (FIG. 8) radially outward through the Bernoulli passage 82 to its terminus and then exit the system through discharge ports 80 and discharge passage 84. Unlike the rotor configuration shown in FIGS. 1-8, the FIG. 9 rotor configuration, Bernoulli fluid flow is diverted before reaching the workpiece peripheral edge to avoid interrupting the protective rim/workpiece interface at the edge of the workpiece W. Consequently, the FIG. 9 modification will provide a physical barrier to processing fluids, preventing processing fluids from reaching the interiorly-exposed surface 73 of the workpiece W.

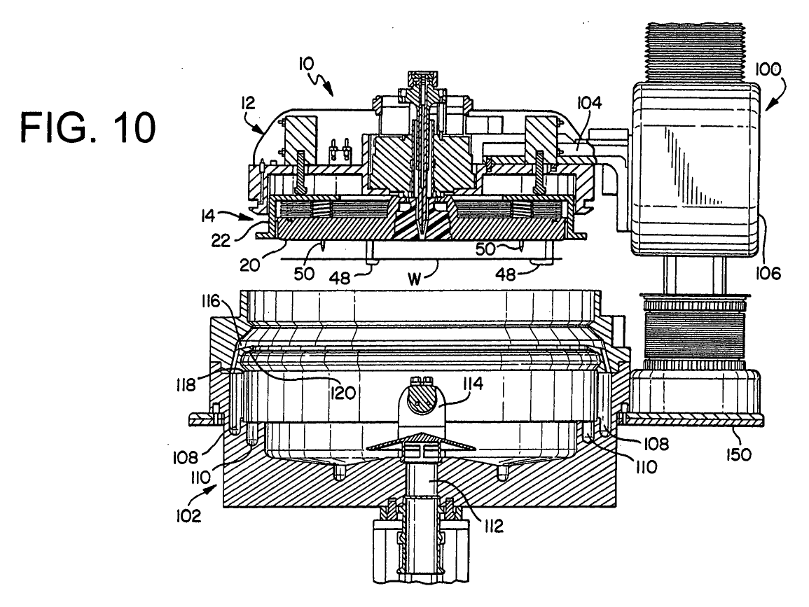

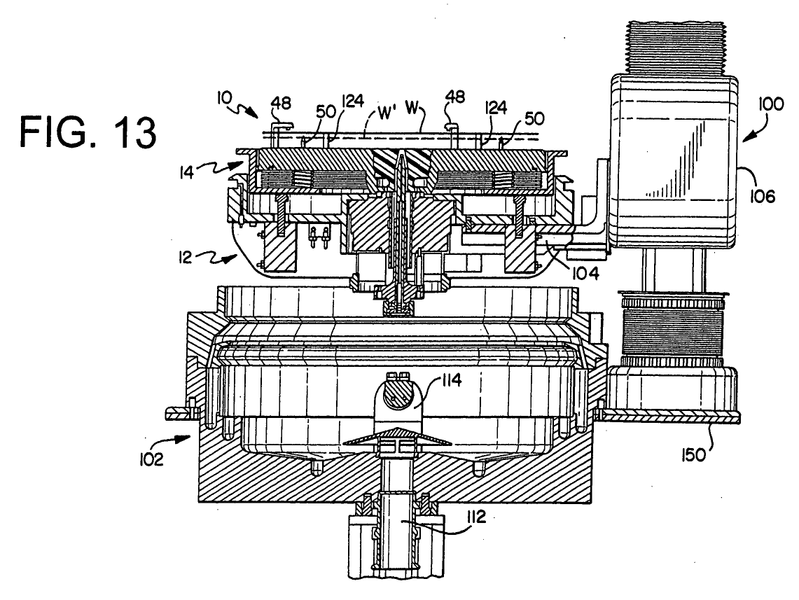

FIGS. 10-12 show the drive head assembly 10, as described with reference to FIGS. 1-8, mounted by a lift/rotate 100 over a processing vessel 102. The lift/rotate actuator 100 includes an arm 104 that attaches the drive head 10 to an elevator mechanism 106. The elevator mechanism 106 may also include a mechanism for rotating the drive head 10 from a position as shown in FIGS. 10-12 to a position shown in FIG. 13.

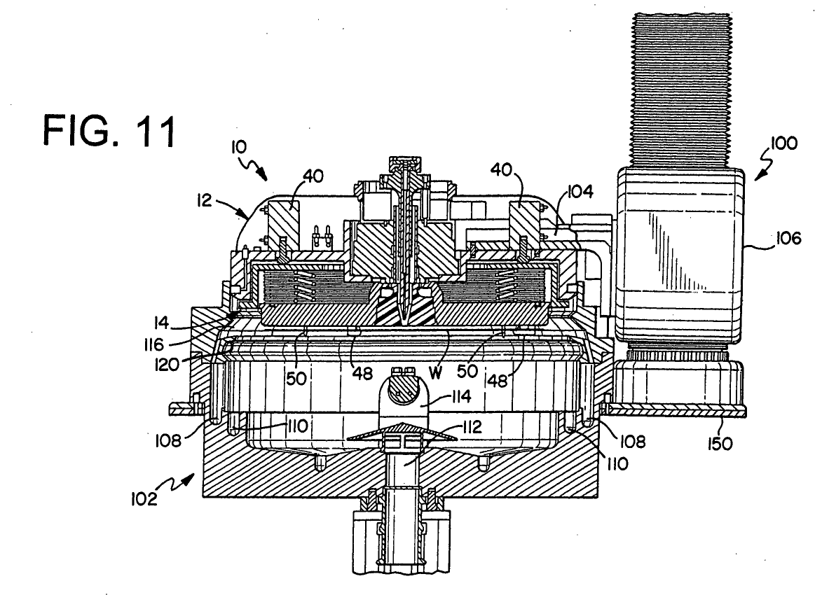

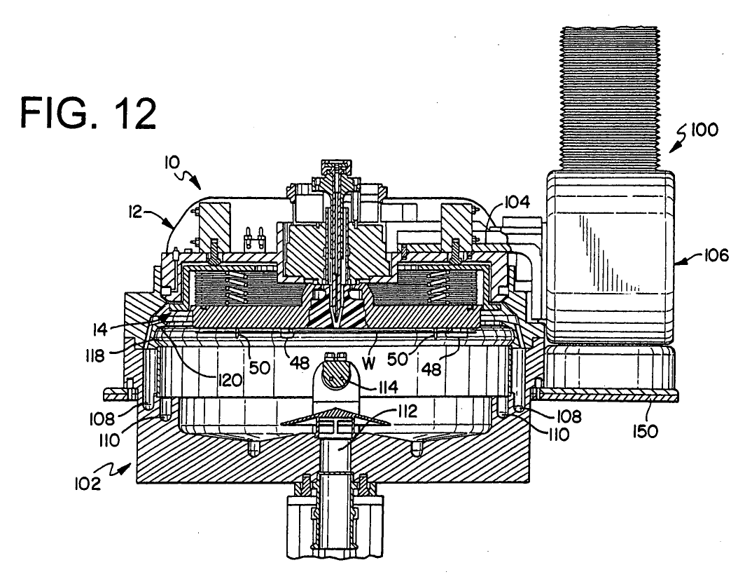

In FIG. 10, the rotor 20 and workpiece support 22 are arranged for loading or unloading a workpiece W onto or from the support fingers 48. As described in the foregoing, the relationship between the support fingers 48 and the radial pins 50 provides sufficient clearance that a workpiece end effector may insert and remove the workpiece from the drive head 10. FIGS. 11 and 12 show the drive head 10 lowered by the lift/rotate elevator mechanism 106 sufficient to locate the workpiece W within the vessel 102 for processing. Vessel 102 has one or more processing fluid inlets and one or more processing fluid discharge outlets. As shown in FIGS. 10-12, two fluid discharge outlets 108 and 110 are provided. Also as shown in FIGS. 10-12, one fluid inlet 112 is provided with a multi-fluid distributor 114.

As shown in FIGS. 11 and 12, the workpiece W is located in the loaded position, and Bernoulli fluid has been applied to draw the workpiece up closely adjacent the rotor 20 as previously described. During processing, one or more processing fluids, which may be liquids or gases or both, are directed by the distributor 114 against the exposed surface of the workpiece W. The workpiece W will be spun during processing and, consequently, the processing fluids will contact the workpiece and flow under centrifugal force outward to the periphery of the workpiece, and flung radially off the workpiece. With the drive head 10 in the position shown in FIG. 11, the processing fluids flung from the workpiece W will contact the vessel and be directed down through passage 116 to the discharge outlet 108. With the drive head in the position shown in FIG. 12, the processing fluids flung from the workpiece will contact the vessel and be directed down through passage 118 to the discharge outlet 110. A deflector 120 is located between the entries to passages 116 and 118 to separate their respective inlets.

It is typical in the semiconductor fabrication industry to transfer semiconductor wafers in a “face-up” position in which the device side of the wafer faces up. And it is typical to load semiconductor wafers into/onto a wafer support associated with a processing vessel in a “face-up” condition. Accordingly, the arrangement shown in FIGS. 10-12, in accordance with that custom, would be appropriate for processing semiconductor wafers in the device side “face-up” orientation such that (as shown) the backside of the wafer W is presented to the processing fluids. This arrangement would be appropriate for cleaning and etching the backside of semiconductor wafers. The advantage of the drive head 10 described in the foregoing is that the backside of a wafer W can be contacted with processing fluids in a manner such that the backside is completely exposed due to the Bernoulli effect lifting the wafer clear of the support fingers 48. In addition, a further advantage is that the device side of the wafer W does not contact any structure and therefore that side is maintained in an unmarred condition. Referring specifically to the FIG. 9 modifications of the rotor 20, these modifications afford entirely adequate protection of the device side of a wafer W because the diverter 76 only contacts the peripheral “exclusion zone” on which no devices are manufactured.

In addition to the foregoing, the drive head 10 and lift/rotate 106 assemblies enable the drive head 10 to be rotated so that it is inverted to the position shown in FIG. 13. When the drive head 10 is inverted as shown in FIG. 13, a semiconductor wafer W can be loaded onto the support fingers 48 with the device side facing up, consistent with conventional practice. As will be described in detail following, several standoffs are provided in the rotor to support the wafer when it is placed in the position shown in FIG. 13, the wafer is secured to the rotor 20, and the drive head 10 is rotated to the position shown in FIG. 10. Then the wafer W can be processed as described with reference to FIGS. 10-12, the difference being, however, that the device side of the wafer W is now presented to the processing fluid, rather than the backside. So in summary: if a wafer backside is to be exposed to processing fluid, the wafer is loaded onto the drive head 10 by being deposited onto the support fingers 48 with the device side facing upward (i.e., adajacent to the rotor surface) as seen in FIGS. 10-12; but if the wafer device side is to be exposed to processing fluid, the wafer is loaded onto the drive head by being deposited onto standoffs (as described following) with the device side facing upward (i.e., the backside adjacent the rotor surface) as seen in FIG. 13 with the drive head inverted.

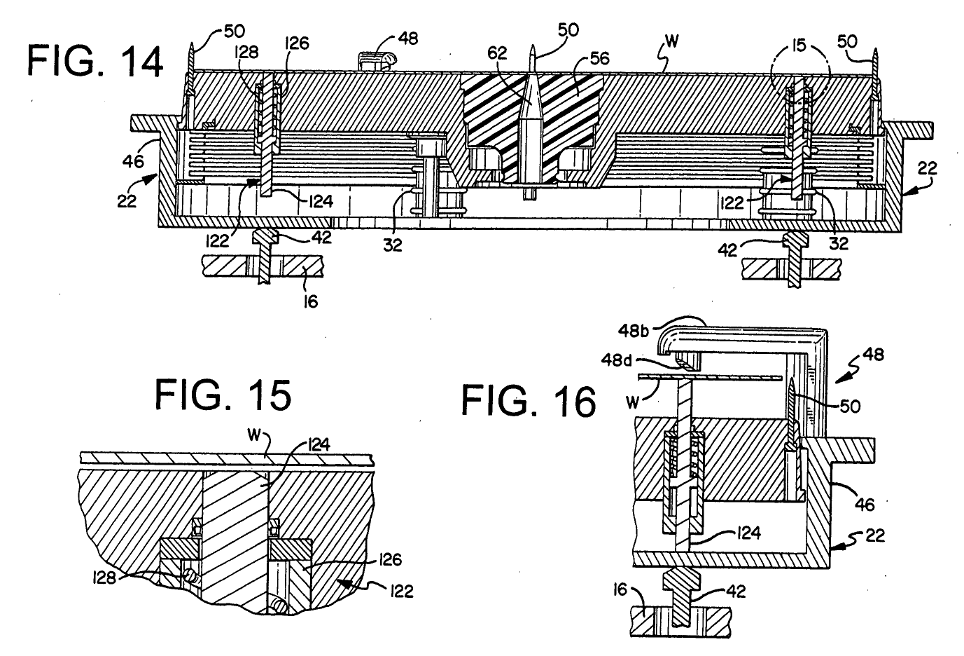

The rotor/wafer support assembly shown in FIGS. 14-16 is identical with the assembly shown in FIGS. 1-9, except for the provision of several standoffs 122 for supporting a workpiece W when the drive head 10 is inverted to the position shown in FIG. 13. Each standoff 122, comprises a lift pin 124, a lift pin sleeve 126 and a lift pin coil spring 128. The lift pin 124 extends through both ends of the sleeve 126 and includes a collar against which the spring 128 bears to maintain the lift pin 124 in a normally retracted position as shown in FIG. 14. As shown in FIG. 15, the outer end of pin 124 is configured to contact and support a workpiece W. The inner end of pin 124 extends a sufficient length beyond the sleeve 126 to enable the workpiece support spring plate 16 to contact and displace it against the spring force of spring 128.

When a workpiece is to be loaded onto the drive head 10 in the inverted position shown in FIG. 13, the pneumatic cylinders 40 are actuated to extend their cylinder rods 42 to bear against the spring plate 16. The support 22 is then extended to a position as shown in FIG. 16 at which the workpiece contact end is located between the radial pins 50 and the support finger guide surface 48c. At this extended position, a workpiece W may be loaded onto the drive head 10 by an end effector that inserts the workpiece between the pins 50 and the guide surface 48c and then lowers the workpiece onto the lift pins 124. Then, the pneumatic cylinders 40 are deactivated so as to permit the springs 32 to force the support 22 to retract, thereby releasing the lift pin 124 so that it will retract and lower the workpiece W from that shown in FIG. 16 to that shown in FIG. 14. When the workpiece is in the position shown in FIG. 14, it is confined between the several guide pins 50 and the guide surfaces 48c of the several support fingers 48. The Bernoulli fluid flow is then activated to draw the workpiece to the rotor and then the drive head can be rotated 180 deg. to the position shown in FIG. 10, with the workpiece ready for processing.

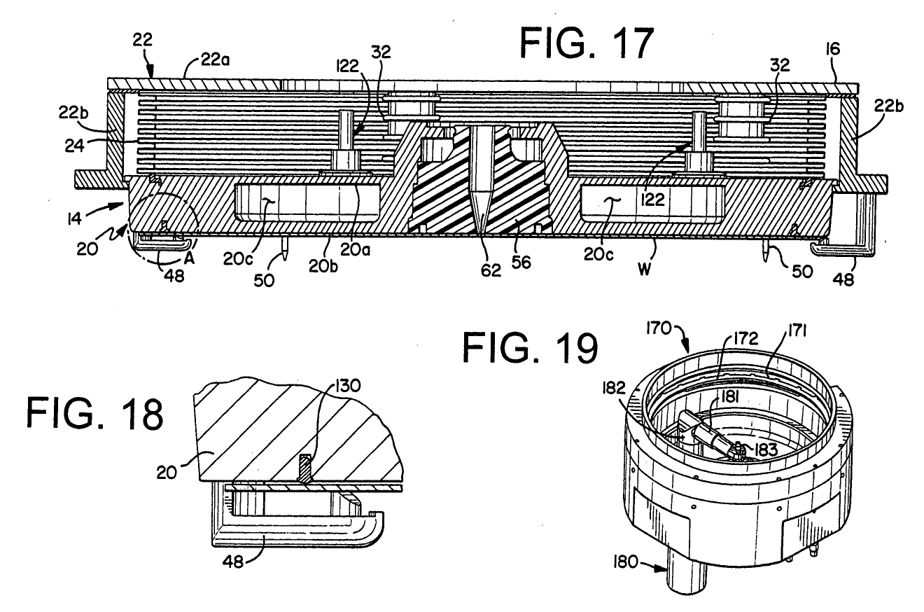

FIG. 17 illustrates a modified rotor 20 structure. In this configuration, the rotor 20 is fabricated with a top plate 20a and a chemically-resistant plastic bottom plate 20b. Bellows seal 24 is fastened between the upper edge of bottom plate 20b and top plate 20a. Bottom plate 20b has an annular recessed section 20c for weight reduction. Top plate 20a is fastened to the spin motor (not shown in this Fig). FIG. 17 also illustrates a modified support 22 structure. In this configuration, the support 22 is fabricated with a top plate 22a and a chemically-resistant plastic rim or skirt section 22b. Bellows seal 24, also chemically-resistant, is fastened between the upper edge of skirt 22b and top plate 22a. In this configuration, as well as in the other configurations illustrated in the drawings, bellows seal 24 protects the interior regions of the drive head from vapors and other fluids that might emanate from the processing vessel.

FIG. 18 illustrates the provision of a standoff pin 130 to limit the distance to which the Bernoulli fluid can draw the workpiece W toward the rotor 20 to a predetermined space S. Several such pins 130 would be located around the periphery of the rotor such that they would contact the workpiece in the “exclusion zone” of the workpiece. This series of pins 130 would be provided as an alternative to the structure shown in FIG. 9. As a consequence of being drawn against the standoff pins 130, the workpiece will spin in synchronism with the rotor.

With reference to the FIG. 13 embodiment, when the Bernoulli fluid flow is activated, the Bernoulli effect would cause the workpiece W to be drawn against the standoff pins 130 of FIG. 18, when those pins are provided, or against the diverter workpiece surface 78a of FIG. 9, when the diverter of FIG. 9 is provided. In the absence of some means of contacting the workpiece during operation, such as shown in FIG. 9 (surface 78a) or FIG. 18 (pins 130), the workpiece might not spin at all while the rotor spins, or might rotate only slightly (i.e., at a spin rate less than the spin rate of the rotor). In some processes, it would be essential that the workpiece spin to a significant degree and, so, such means would be an important addition to the drive head. Furthermore, in some processes, it would be essential that the workpiece spin in synchronism with the rotor (i.e., at approximately the same spin rate) such that the surface of the workpiece would not be marred or scraped by such means.

All other elements of the rotor structure 20 and support structure 22 shown in FIGS. 17 and 18 are as described in the foregoing description with respect to the other Figs.

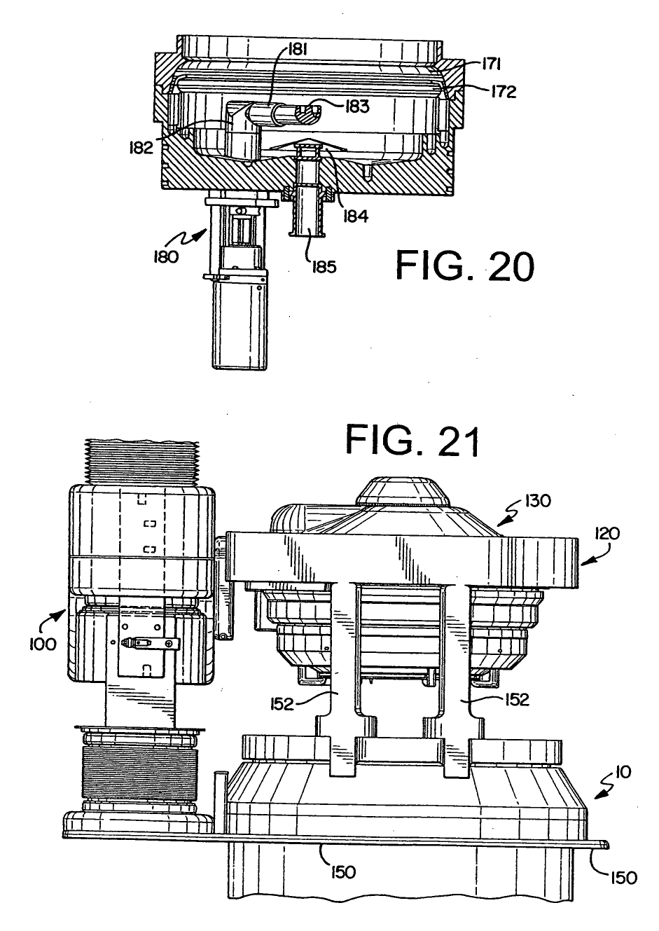

A preferred embodiment of the bowl 170 for use in the vessel 102 of the present invention is shown in FIGS. 19 and 20. A process fluid delivery system 180 is centrally positioned in a lower portion of the bowl 170. The process fluid delivery system 180 is pivotable and includes swing arm 181 which pivots about along an axis defined by vertically disposed standpipe 182. At one end of the swing arm 181 is at least one nozzle 183, and preferably a plurality of nozzles 183 for spraying process fluid into the bowl 170, and particularly onto a lower planar surface of a workpiece W positioned in the process chamber 140. The nozzles 183 are connected (via passageways in the vertical standpipe 182 and swing arm 181) to supply sources of process fluids. Examples of process fluids that can be used in the present invention include: nitric acid, sulfuric acid, hydrofluoric acid, phosphoric acid, potassium hydroxide and de-ionized water. The pivotable delivery system 180 permits process fluid to be uniformly applied to the workpiece W from the center point radially outward to the outer edge of the workpiece W. An exhaust port 184 is positioned in the bottom of the bowl 170 below the swing arm 181, and is connected to drain 185 for removing gaseous fluids which may build up in the process chamber 140 during processing.

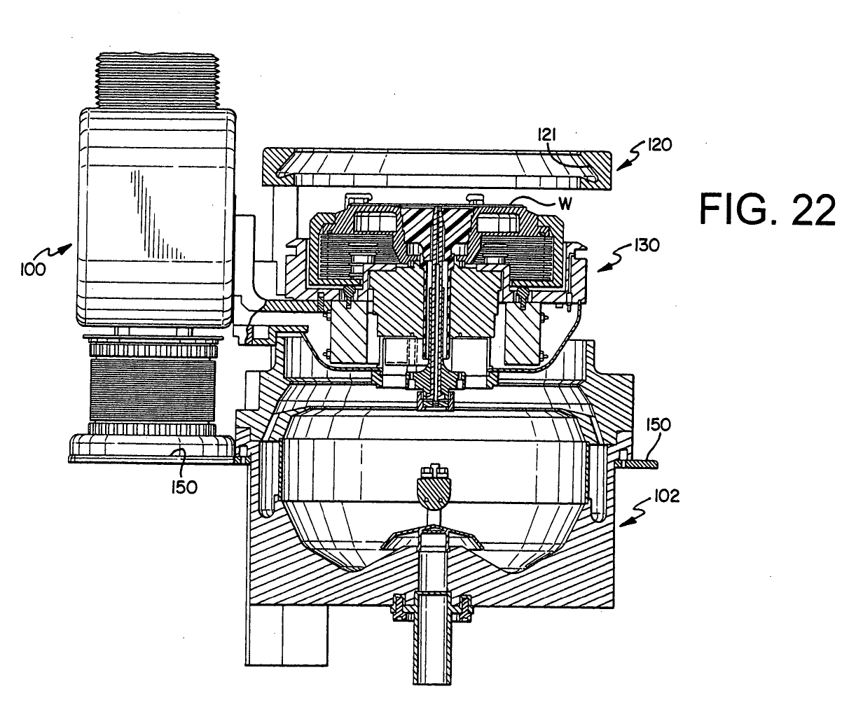

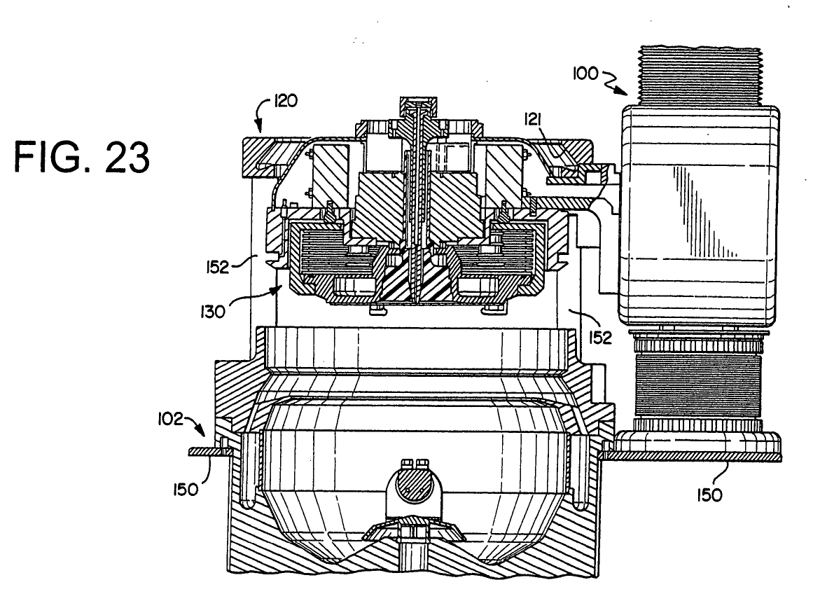

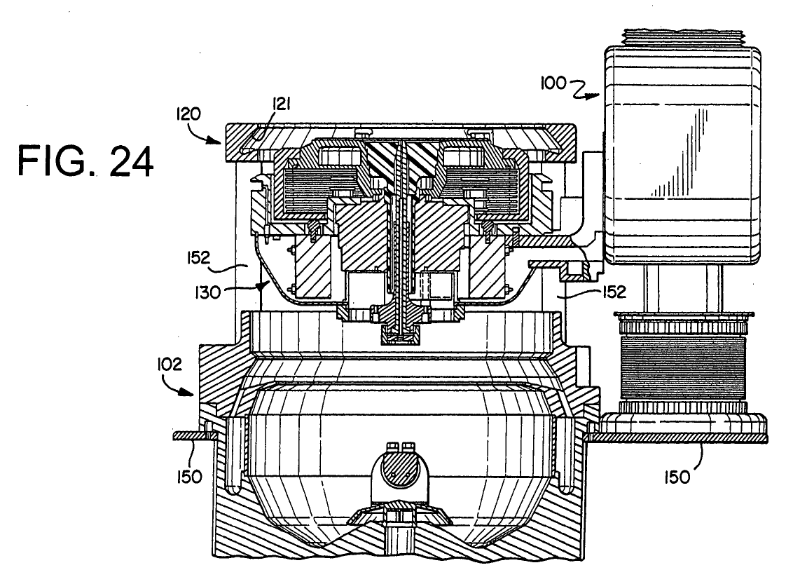

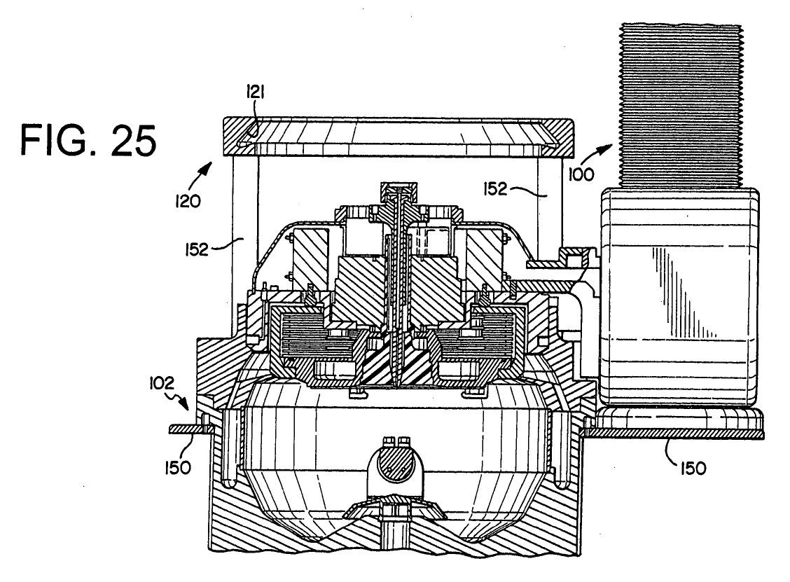

The reactor comprising the drive head 10 and the reactor vessel 102 can be augmented by the addition of a second processing apparatus. As shown in FIGS. 21-25, an additional processing vessel 120 is provided above the vessel 102. The lift/rotate actuator 100 positions the drive head 130 between the two vessels for workpiece loading/unloading. With a workpiece W loaded onto the drive head, the drive head may insert the workpiece into either vessel, as shown in FIGS. 24 and 25, or sequentially into both vessels. When accessing the upper vessel 120, the drive head would be located in the inverted position as shown in FIGS. 13, 22 and 24. Then the drive head would be elevated by the lift/rotate 100 to place the workpiece W into the upper vessel 120 as shown in FIG. 24. In the inverted position shown in FIG. 24, the workpiece may be processed with fluids directed from above the workpiece. For example, with the upper vessel 120 configured as a rinse rim having a rinse fluid collection channel 121 opening inward as shown in FIGS. 22-25, an overhead rinse delivery apparatus (not shown) can apply a rinsing fluid, such as DI water, onto the workpiece W. Because the workpiece spins during processing, as described hereinabove, the rinse fluid runs radially outward under the influence of centrifugal force and is flung from the workpiece perimeter into the collection channel 121. Collection channel 121 is provided with an appropriate drain through which the collected rinse fluid drains. As shown, rinse rim 120 is supported from a tool platform base structure 150 by support legs 152. Support legs 150 may be secured directly to the platform base structure 150 or they may be secured to an upper section of the lower vessel 102 as shown in FIG. 21. The lower vessel 102 and the lift/rotate 100 are also secured to the tool platform base structure 150 as shown in FIGS. 21-25. Likewise, lift/rotate 100 and vessel 102 illustrated in FIGS. 1 and 2 is secured to a tool platform base structure 150.

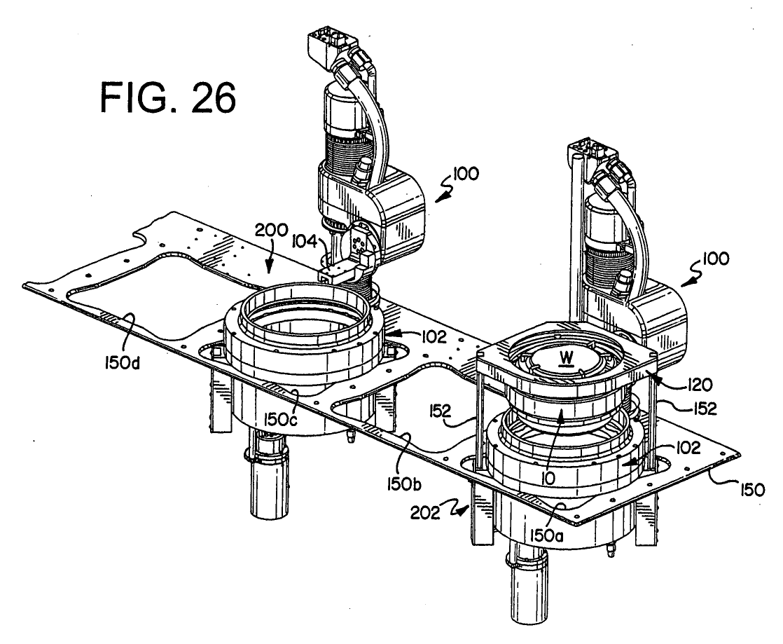

FIG. 26 illustrates two processing stations arranged side-by-side on a tool platform base 150. One station 200 illustrates the lift/rotate 100 and processing vessel 102 with the drive head absent for clarity of the arrangement. The other stations 202 illustrates the lift/rotate 100, the lower processing vessel 102, the upper processing vessel 102, and the drive head 10 in the inverted position with a workpiece W in place for processing in the upper vessel. As shown in FIG. 26, the base 150 is provided with a series of cutouts 150a-d into which processing stations can be registered and positioned. Appropriate indexing holes and pegs can be provided to register the processing station components, such as lift/rotated, processing vessels, and related support apparatus.

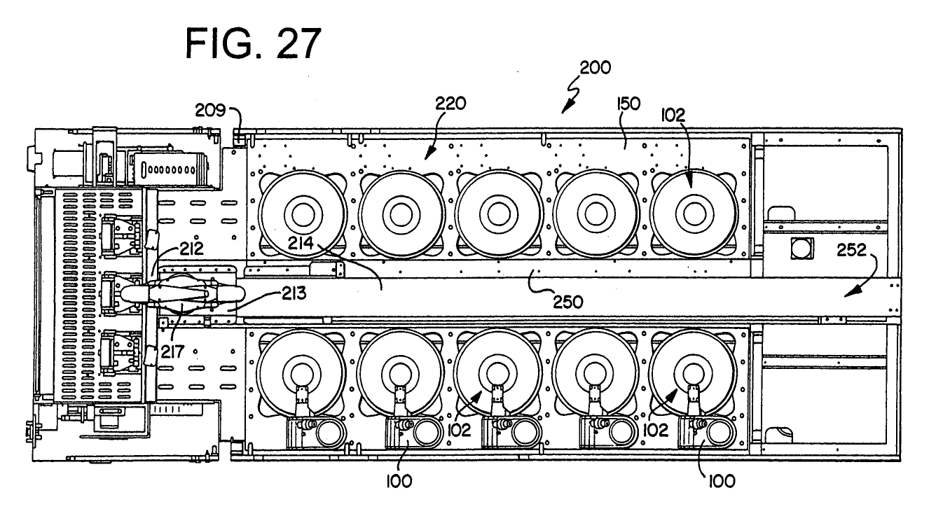

FIG. 27 is an isometric view showing a portion of a system or integrated tool 200 configured in accordance with an embodiment of the invention. In this embodiment, the integrated tool 200 includes a frame 209, a dimensionally stable mounting module 250 mounted to the frame, and a plurality of wet chemical processing stations 220, each having a process vessel 102 and a lift/rotate actuator 100. The process vessels 102 are configured to perform a variety of functions including but not limited to electrochemical processing, electroless processing, etching and/or rinsing. The system 200 can also include a transport system 212 that has a robot 213 with one or more end-effectors 217. The transport system 212 is mounted to the mounting module 250. The mounting module 250 supports the process vessels 102, the lift/rotate actuator 100, and the transport system 212. In one embodiment (shown in FIG. 1), the mounting module 250 includes a dimensionally stable deck or base 150 and a dimensionally stable platform 252 (located for example below the deck 150). The transport system 212 is mounted to the platform 252. A track 214 is also mounted to the platform 252. In another embodiment (not shown) the transport system 212 can be mounted directly to the deck 150. A modular load/unload system 215 is attached to the mounting module 250 at one end. In operation, the robot 213 takes workpieces from the load/unload module 215, travels along the track 214, and places the workpieces into one or more process vessels 102 for treatment. Other aspects of the system 200 are disclosed in pending U.S. application Ser. Nos. 10/691,688, filed on Oct. 22, 2003, and Ser. No. 10/690,864, filed on Oct. 21, 2003. The disclosures of these Applications are fully incorporated herein by reference.

From the foregoing, it will be appreciated that specific embodiments of the invention have been described herein for purposes of illustration, but that various modifications may be made without deviating from the spirit and scope of the invention, including, but not limited to, variations in size, materials, shape, form, function and manner of operation, assembly and use.

We claim:

1. A workpiece support apparatus for use in a workpiece process chamber, the apparatus comprising:
a rotor having a central cavity and guide pins mounted at an outer perimeter;
a workpiece support having extendable workpiece support fingers, the extendable workpiece support fingers moveable from a first position to a second position;
a motor for spinning the rotor;
a fluid delivery tube positioned in the central cavity of the rotor and connected to a supply of fluid;
wherein when the extendable workpiece support fingers are in the first position, the guide pins of the rotor cannot interfere with the loading of a workpiece onto the extendable workpiece support fingers,
and when the extendable workpiece support fingers are in the second position, a pressurized fluid is delivered through the delivery tube to create a low pressure region adjacent an inner surface of the workpiece, lifting the workpiece off the extendable workpiece support fingers, while the guide pins maintain the workpiece in an axial-centered position.

2. The apparatus of claim 1, wherein the extendable workpiece support fingers are operably connected to an actuator for moving the extendable workpiece support fingers from the first position to the second position.

3. The apparatus of claim 1, wherein the workpiece support comprises a support plate and a peripheral skirt.

4. The apparatus of claim 3, wherein the extendable workpiece support fingers are connected to the peripheral skirt.

5. The apparatus of claim 1, wherein the extendable workpiece support fingers are comprised of a vertical leg and a horizontal leg.

6. The apparatus of claim 5, wherein the horizontal leg has one end comprised of a generally horizontal workpiece contact surface and a generally slope workpiece centering surface.

7. The apparatus of claim 1, wherein the fluid delivery tube comprises a nozzle at one end.

8. The apparatus of claim 7, wherein the nozzle is comprised of a plurality of fluid delivery ports that extend radially through the fluid delivery tube.

9. The apparatus of claim 1, wherein the fluid discharged from the delivery tube flows radially outward toward the periphery of the workpiece.

10. The apparatus of claim 1, wherein the rotor has at least one retractable lift pin located radially inwardly from the guide pins.

11. The apparatus of claim 1 further comprising a bellows seal connecting the workpiece support to the rotor.

12. The apparatus of claim 1, wherein the rotor has a fluid flow diverter member at an outer edge thereof.

13. A drive head assembly for use in a process vessel for treating a microelectronic workpiece, the drive head assembly comprising:
a rotor having guide pins mounted at an outer perimeter;
a motor for spinning the rotor;
a workpiece support having extendable workpiece support fingers for receiving the workpiece, the extendable workpiece support fingers moveable from a first position, wherein the support fingers extend beyond the guide pins to allow a workpiece to be placed on the support fingers, to a second position, wherein the guide pins confine the outer periphery of the workpiece; and
a fluid pathway running through the drive head assembly for delivering a fluid to one side of the workpiece at a flow rate sufficient to create a low pressure zone adjacent to the one side of the workpiece thereby lifting the workpiece off the support fingers

14. The drive head assembly of claim 13 further comprising a bellows seal connecting the workpiece support to the rotor.

15. The drive head assembly of claim 13 further comprising an actuator for extending the workpiece support fingers into the first position.

16. The drive head assembly of claim 15 further comprising a coil spring for moving the extendable workpiece support fingers from the first position into the second position.

17. The drive head assembly of claim 13, wherein the guide pins are spaced 90 degrees apart around the periphery of the rotor.

18. The drive head assembly of claim 13, wherein the extendable workpiece support fingers are generally L-shaped.

19. The drive head assembly of claim 18, wherein the generally L-shaped support fingers comprise a workpiece contact surface and a sloped workpiece centering surface.

20. The drive head assembly of claim 13, wherein the fluid pathway comprises a tube extending axially through the motor and the rotor.

21. The drive head assembly of claim 20, wherein the tube has a nozzle at one end thereof.

22. The drive head assembly of claim 20 further comprising a plurality of fluid delivery ports extending radially through the tube.

23. The drive head assembly of claim 13 further comprising a fluid flow diverter attached to the outer edge of the rotor.

24. A process vessel for treating a microelectronic workpiece comprising:
a bowl having a drain;
a drive head assembly comprising:
a rotor having a plurality of guide pins mounted at an outer perimeter;
a workpiece support having extendable workpiece support fingers for receiving the workpiece, the extendable workpiece support fingers moveable from a first position, wherein the support fingers extend beyond the guide pins to allow a workpiece to be placed onto the support fingers, to a second position, wherein the guide pins confine the outer periphery of the workpiece;
a motor connected to the rotor for spinning the rotor; and
a fluid pathway extending through the rotor for delivering a fluid to one side of the workpiece to create a low pressure zone adjacent to the one side of the workpiece thereby lifting the workpiece off the support fingers and exposing a second side of the workpiece for processing,
an actuator connected to the drive head assembly for selectively raising and lowering the drive head assembly;
a process fluid delivery system positioned in the bowl for delivering a process fluid to the second side of the workpiece.

25. The process vessel of claim 24, wherein the drain is comprised of first and second annular channels formed in the bowl.

26. The process vessel of claim 25 further comprising a deflector, which separates the first and second channels.

27. The process vessel of claim 24, wherein the drive head assembly is rotatably connected to the lift actuator.

28. The process vessel of claim 24 further comprising a gas exhaust port positioned in the bowl.

29. The process vessel of claim 24, wherein the rotor has at least one retractable lift pin located radially inwardly from the guide pins.

30. The process vessel of claim 24, wherein the motor spins the rotor and the workpiece.

31. The process vessel of claim 24, wherein the motor spins the rotor but not the workpiece.

32. The process vessel of claim 30, wherein the rotor spins at a rate greater than a spin rate of the workpiece.

33. The process vessel of claim 30, wherein the rotor and the workpiece spin at approximately the same rate.

34. An apparatus for processing a microelectronic workpiece having a device side and a backside, the apparatus comprising:
a first process vessel;
a second process vessel positioned below the first process vessel;
a drive head assembly rotatably connected to a lift actuator for moving the workpiece from the first process vessel to the second process vessel, the drive head assembly comprising:
a rotor having guide pins mounted at an outer perimeter;
a motor for spinning the rotor;
a workpiece support having extendable workpiece support fingers for receiving the workpiece, the extendable workpiece support fingers moveable from a first position, wherein the support fingers extend beyond the guide pins to allow a workpiece to be placed on the support fingers, to a second position, wherein the guide pins confine the outer periphery of the workpiece; and
a fluid pathway running through the drive head assembly for delivering a fluid to one side of the workpiece at a flow rate sufficient to create a low pressure zone adjacent to the one side of the workpiece thereby lifting the workpiece off the support fingers.

35. The apparatus of claim 34, wherein the drive head assembly has a first load position allowing the workpiece to be loaded with the backside of workpiece adjacent the rotor.

36. The apparatus of claim 34, wherein the drive head assembly has a second load position allowing the workpiece to be loaded with the device side of the workpiece adjacent the rotor.

37. The apparatus of claim 34, wherein the rotor has at least one retractable lift pin located radially inwardly from the guide pins for receiving the backside of the workpiece when the drive head assembly is loaded in the first position.

38. The apparatus of claim 34, wherein the extendable workpiece support fingers receive the backside of the workpiece when the drive head assembly is loaded in the second position.

39. The apparatus of claim 37, wherein the lift actuator moves the drive head assembly into the first process vessel for processing the device side of the workpiece.

40. The apparatus of claim 38, wherein the lift actuator moves the drive head assembly into the second process vessel for processing the backside of the workpiece.

41. The apparatus of claim 34, wherein the motor spins the rotor and the workpiece.

42. The apparatus of claim 34, wherein the motor spins the rotor but not the workpiece.

43. The apparatus of claim 41, wherein the motor spins the rotor at a rate greater than a spin rate of the workpiece.

44. The apparatus of claim 41, wherein the rotor and the workpiece spin at approximately the same rate.

45. A system for processing a workpiece, comprising:
a plurality of workpiece stations, with at least one station having a process vessel comprising:
a bowl having a drain;
a drive head assembly comprising:
a rotor having a plurality of guide pins mounted at an outer perimeter;
a workpiece support having extendable workpiece support fingers for receiving the workpiece, the extendable workpiece support fingers moveable from a first position, wherein the support fingers extend beyond the guide pins to allow a workpiece to be placed onto the support fingers, to a second position, wherein the guide pins confine the outer periphery of the workpiece;
a motor connected to the rotor for spinning the rotor and the workpiece; and
a fluid pathway extending through the rotor and the motor for delivering a fluid to one side of the workpiece to create a low pressure zone adjacent to the one side of the workpiece thereby lifting the workpiece off of the support fingers and exposing a second side of the workpiece for processing;
an actuator connected to the drive head assembly for selectively raising and lowering the drive head assembly; and
a process fluid delivery system positioned in the bowl for delivering a process fluid to the second side of the workpiece; and
a transport system for moving the workpiece between the workpiece stations.
